(19) United States
(12) Patent Application Publication
(10) Pub. No.: US 2009/0292708 A1
(43) Pub. Date: Nov. 26, 2009

(54) DATA DELIVERY APPARATUS, DATA DELIVERY METHOD, AND DATA DELIVERY PROGRAM

(75) Inventors: Tomonori SATO, Machida-shi (JP); Chiyoko Sawada, Shinjuku-ku (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Chiyoda-ku (JP)

(21) Appl. No.: 12/328,211

(22) Filed: Dec. 4, 2008

(30) Foreign Application Priority Data
May 26, 2008 (JP) 2008-136453

(51) Int. Cl. G06F 17/30

(52) U.S. Cl. 707/10; 707/E17.01

(57) ABSTRACT

A data delivery apparatus comprising: an information acquiring unit for making a connection with an external equipment provided with a delivery destination folder for receiving data for delivery and for acquiring information on data receiving constrains imposed on said delivery destination folder (S110); a confirmation unit for confirming whether said data receiving constrains will be cleared for delivery of said data to said delivery destination folder (S112); and a display unit for displaying, in the case where said confirmation unit confirms that some of said data receiving constrains on said delivery destination folder will not be cleared, an error/warning message indicating that said some data receiving constrains will not be cleared (S113).

### CROSS-REFERENCE TO RELATED APPLICATION

This application is based on Japanese Patent Application No. 2008-136453 filed on May 26, 2008, the contents of which are incorporated herein by reference.

### BACKGROUND

1. Technical Field

The present invention relates to a data delivery apparatus, a data delivery method, and a data delivery program for delivering data such as an image file generated by a scanner to external equipment such as a file server.

2. Description of Related Art

In recent years, many offices are equipped with scanners connected to a network, and image data generated by the scanners are delivered to external equipment such as file servers via the network.

However, when a file server of data delivery destination is equipped with a document management application, folders for receiving the data are normally subject to various data receiving constrains (e.g., constrains in receivable data format or data size).

Therefore, user's instruction to delivery image data produced by a scanner will end up in a delivery error unless those data receiving constrains are cleared. However, under normal circumstances, users cannot identify the reason for the delivery error, and hence needs to take a lot of trouble in fixing the error.

With respect to this problem, Unexamined Japanese Patent Publication No. 2003-177997 proposes a method executed by a data transmission system for transmitting image data from an MFP to a personal computer (PC), comprising the steps of specifying the data format that can be made available for display by the software installed on the PC, and then allowing user only to select the specified data format for the data for transmission.

Unexamined Japanese Patent Publication No. 2004-280607 also proposes a method executed by a data transmission system for transmitting image data from a multifunctional peripheral to a plurality of PCs, comprising the steps of specifying PCs that are equipped with shared folders, and then allowing user only to select the specified PCs as delivery destination hosts.

Unexamined Japanese Patent Publication No. 2004-348337 proposes a method executed by a data transmission system for transmitting image data from a multifunctional peripheral to a plurality of PCs, comprising the steps of producing a control table for managing the power-on/power-off status of PCs integrally, and displaying the power-on/power-off status so that the power-on PCs and the power-off PCs can be distinguished from each other.

However, since there are so many kinds of data receiving constrains imposed by a document management application in general, it is still difficult for those using the methods proposed by the aforementioned Patent Publications, to identify the reason for a delivery error when the delivery error occurs due to a particular data receiving constrain.

The present invention is made to solve the abovementioned problem of the prior art and the purpose of the present invention is to provide a data delivery apparatus, a data delivery method, and a data delivery program which can display information on availability of data delivery to folders with data receiving constrains imposed by a document management application, etc., as well as the reason for non-availability of the data delivery as appropriate, prior to actual data delivery.

### SUMMARY

To achieve at least one of the above mentioned objects, a data delivery apparatus for delivering data to one or more folders on an external equipment, reflecting an aspect of the present invention, comprises a folder designating unit, an information acquiring unit, a confirmation unit, and a display unit.

Said folder designating unit designates a delivery destination folder to which said data is to be delivered.

Said information acquiring unit makes a connection with said external equipment containing said delivery destination folder, and acquires information on data receiving constrains imposed on said delivery destination folder.

Said confirmation unit confirms whether or not said data receiving constrains will be cleared for data delivery to said delivery destination folder, based on the information acquired by said acquiring unit.

Said display unit displays, in the case where said confirmation unit confirms that some of said data receiving constrains on said delivery destination folder will not be cleared, information indicating that said some data receiving constrains will not be cleared.

In said data delivery apparatus, said data receiving constrains preferably include at least one of the following constrains: a constrain in data format of said data, a constrain in data size of said data, a constrain based on whether or not check-out of any existing data in said delivery destination folder is currently in progress for the purpose of version management of said existing data, and a constrain based on whether or not data delivery to said delivery destination folder needs approval.

In said data delivery apparatus, at least part of said folders are preferably managed by a document management application installed on said external equipment, and said data receiving constrains on said folders managed by said document management application are prescribed by said document management application.

The objects, features, and characteristics of this invention other than those set forth above will become apparent from the description given herein below with reference to preferred embodiments illustrated in the accompanying drawings.

### BRIEF DESCRIPTION OF THE DRAWINGS

FIG. 1 is a block diagram showing the overall configuration of the image forming system according to the first embodiment of the present invention.

FIG. 2 is a block diagram showing the overall configuration of the Multi-Functional Peripheral (MFP) according to the first embodiment of the present invention.

FIG. 3 is a block diagram showing the overall configuration of the PC according to the first embodiment of the present invention.

FIG. 4 is a block diagram showing the overall configuration of the storage unit of the PC according to the first embodiment of the present invention.

FIG. 5 is a block diagram showing the overall configuration of the file server according to the first embodiment of the present invention.

FIG. 6 is a block diagram showing the overall configuration of the storage unit of the file server according to the first embodiment of the present invention.

FIG. 7 is a diagram for describing the configuration of the address folder database.

FIG. 8 is a flowchart showing the sequence of the data delivery process according to the first embodiment of the present embodiment.

FIG. 9 is a diagram showing an example of the UI screen for login authentication according to the first embodiment of the present invention.

FIG. 10 is a diagram showing an example of the UI screen for setting for scanning according to the first embodiment of the present invention.

FIG. 11 is a diagram showing an example of the UI screen for folder designation according to the first embodiment of the present invention.

FIG. 12 is a flowchart showing the sequence of the preliminary confirmation process according to the first embodiment of the present embodiment.

FIG. 13 is a flowchart showing the sequence of the preliminary confirmation process according to the first embodiment of the present embodiment.

FIG. 14 is a flowchart showing the sequence of the preliminary confirmation process according to the first embodiment of the present embodiment.

FIG. 15 is a flowchart showing the sequence of the preliminary confirmation process according to the first embodiment of the present embodiment.

FIG. 16 is a diagram showing an example of the error message screen according to the first embodiment of the present invention.

FIG. 17 is a diagram showing an example of the warning message screen according to the first embodiment of the present invention.

FIG. 18 is a diagram showing an example of the warning message screen according to the first embodiment of the present invention.

FIG. 19 is a diagram showing an example of the warning message screen according to the first embodiment of the present invention.

FIG. 20 is a diagram showing an example of the error message screen according to the first embodiment of the present invention.

FIG. 21 is a flowchart showing the sequence of the final confirmation process according to the first embodiment of the present embodiment.

FIG. 22 is a block diagram showing the overall configuration of an image forming system according to a second embodiment of the present invention.

FIG. 23 is a block diagram showing the overall configuration of the storage unit of the MFP according to the second embodiment of the present invention.

FIG. 24 is a diagram showing another example of the UI screen for folder designation according to the first embodiment of the present invention.

FIG. 25 is a diagram showing another example of the UI screen for folder designation according to the second embodiment of the present invention.

### DETAILED DESCRIPTION

### First Embodiment

The embodiment of this invention will be described below with reference to the accompanying drawings.

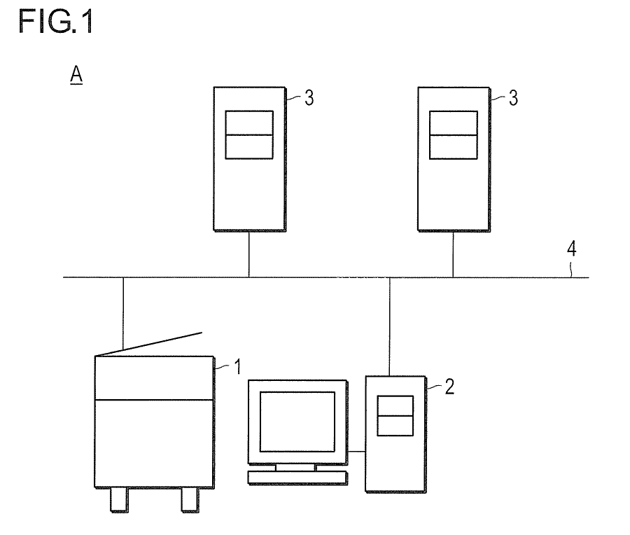

FIG. 1 is a block diagram showing the overall configuration of an image forming system A according to the first embodiment of the present invention. As shown in FIG. 1, the image forming system A contains an MFP 1 equipped with a scanning function for scanning a document to generate image data, a PC 2 (data delivery apparatus) equipped with a data delivery function for delivering the image data generated by the MFP 1 to an external equipment, and one or more file servers 3 which can be delivery destinations of the image data, and all of them are connected via a communication network 4, such as the Internet, LAN, WAN, etc. The types and the number of equipment to be connected to the communication network 4 are not limited to the example shown in FIG. 1.

The configuration of each device will be described below while each device can also include any constituents than those described below, and can only include part of the constituents described below. The description of any function common to more than one device will be made only once, and will not be repeated in order to avoid redundant descriptions.

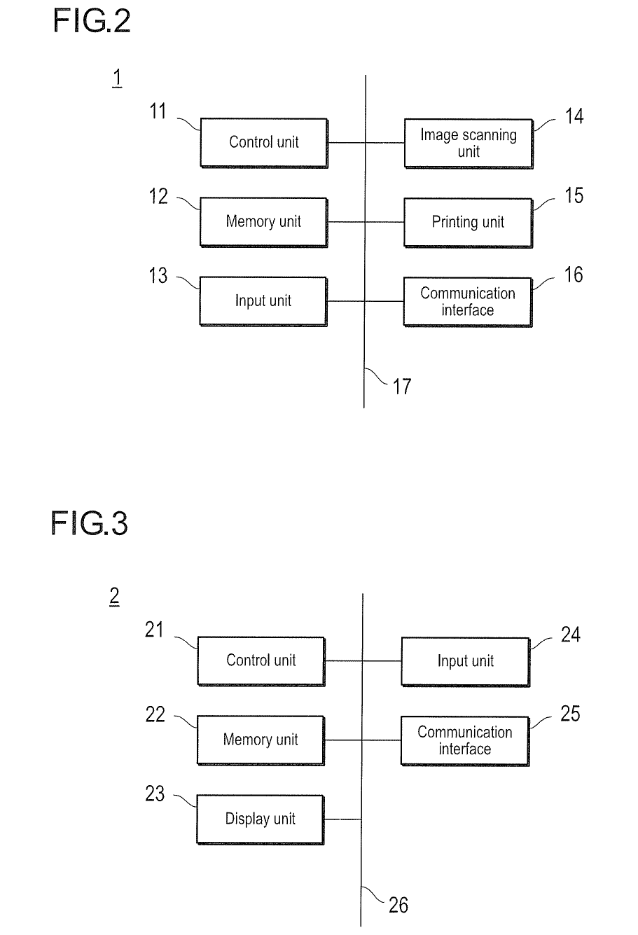

FIG. 2 is a block diagram showing the configuration of an MFP 1 according to the present embodiment. As shown in FIG. 2, the MFP 1 contains a control unit 11, a storage unit 12, an input unit 13, an image scanning unit 14, a printing unit 15, and a communication interface 16, all of which are interconnected via a bus 17 for exchanging signals.

The control unit 11 is a CPU, and controls various parts indicated above and executes various arithmetic processes according to a program.

The memory unit 12 includes a ROM for storing various programs and parameters, a RAM for temporarily storing programs and data, a hard disk used for temporarily storing the image data generated by the scanning of the image scanning device 14, and others.

The input unit 13 consists of a touch panel for displaying various kinds of information or for acquiring various inputs from user, a ten-key unit for acquiring various inputs such as the number of copies to be made, a start key for acquiring instructions to start an operation, a stop key for acquiring instructions to stop an operation, various fixed keys including a reset key for acquiring instructions to initialize various settings, display lamps, etc.

The image scanning unit 14 performs the scanning operation which consists of irradiating by a light source such as a fluorescent lamp a document placed on a specified scanning position on a platen or transferred to a specified scanning position by an ADF (Auto Document Feeder), and converting the scanned image to electrical signals by means of a CCD image sensor or a CMOS image sensor to generate image data (bitmap data) from the electrical signals.

Printing unit 15 prints image data on printing paper by the electronic photography method comprising the steps of electrostatic charging, exposure, development, transferring and fixing, and discharges the printed paper. However, the printing method employed by the printing unit 15 in this invention, is not limited to this, and other printing methods including the impact method, thermal transfer method, inkjet method, etc. can also be used in place of the electronic photography method.

The communication interface 16 is an interface for communications between the MFP 1 and the external equipment, and can typically be a network interface using protocols like Ethernet, Token Ring, and FDDI, a serial interface like USB and IEEE 1394, a parallel interface like SCSI and IEEE 1284, and a wireless communication interface like Bluetooth (a registered trademark), IEEE 802.11, HomeRF and IrDA, as well as a telephone circuit interfaces for connection to telephone circuits.

The abovementioned configuration enables the MFP 1 to function as a scanner for scanning a document and transmitting the scanned image data to an external equipment, a printer for printing image data received from an external equipment, a copying machine for scanning a document and print the scanned image data, and a facsimile machine for receiving and transmitting image data through a telephone circuit.

FIG. 3 is a block diagram showing the configuration of the PC 2 according to the present embodiment. As shown in FIG. 3, the PC 2 contains a control unit 21, a storage unit 22, a display unit 23, an input unit 24, and a communication interface 25, all of which are interconnected via a bus 26 for exchanging signals.

The control unit 21 is a CPU, and controls various parts indicated above and executes various arithmetic processes according to a program. The storage unit 22 consists of a ROM for storing various programs and parameters, a RAM for storing programs and data temporarily as a working area, a hard disk for storing OS (operating system, or basic software), programs, parameters and the likes for controlling various operations of the PC 2, and others.

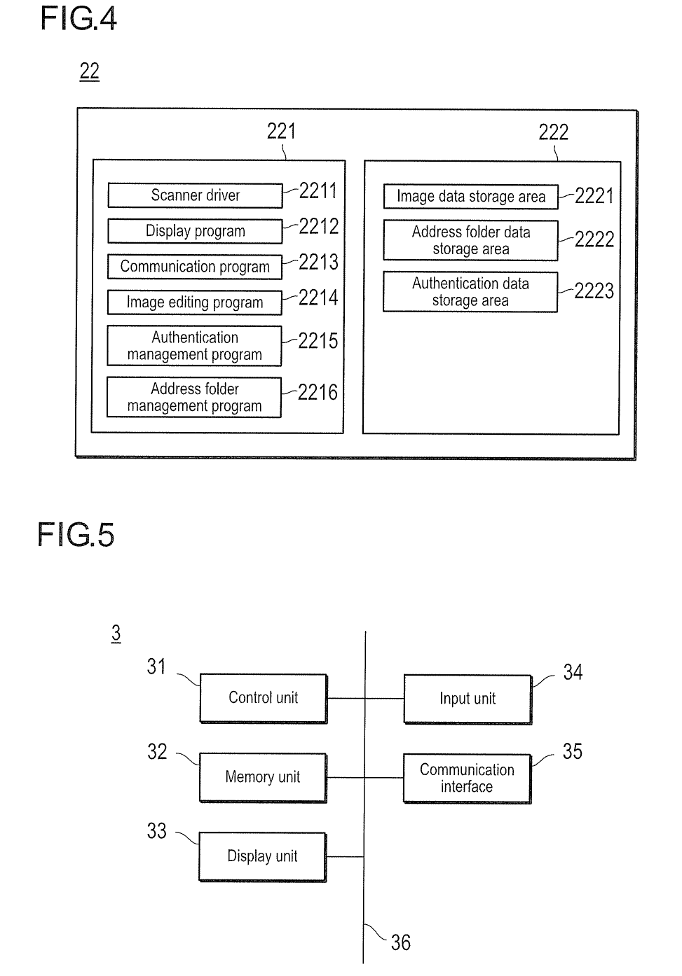

FIG. 4 is a block diagram showing the configuration of the storage unit 22. As shown in FIG. 4, the storage unit 22 includes a program storage area 221 for storing various programs, and a data storage area 222 for storing the image data received from the MFP 1 and parameters and the likes to be referenced during the execution of various programs.

The program storage area 221 stores a scanner driver 2211 for configuring the scanning function of the MFP1 as well as for remote-controlling the MFP 1 so that it can perform the scanning operation, a display program 2212 for displaying on the display unit 23 various UI (User Interface) screens related to settings for the scanning operation in conjunction with the scanner driver 2211, a communication program 2213 for exchanging various data with the MFP 1, the file server 3, and others, an image editing program 2214 for editing the image data received from the MFP 1, a authentication management program 2215 for managing the login authentication to the PC 2, a address folder management program 2216 for managing the folders which has been preliminarily registered as candidates for the delivery destinations (hereinafter also called “address folders”) of the image data generated by the scanning operation (hereinafter also called “scanned image data”), etc.

The data storage area 222 is provided with an image data storage area 2221 for storing the scanned image data received from the MFP 1, an address folder data storage area 2222 for storing the information on each of the address folders, an authentication data storage area 2223 for storing login authentication information of preregistered user to the PC 2, and others.

The display unit 23 is a CRT display, a liquid crystal display and the likes, and displays various kinds of information to user. The display unit 23 particularly displays UI screens u1-u3, error/warning message screens m1-m5, etc. in the course of the scanning operation by the MFP 1. These screens will be described later.

The input unit 24 consists of keyboard, mouse and the likes, for acquiring various instructions from user. The communication interface 24 is an interface for communicating with other devices on the network 3 using protocols such as Ethernet, Token Ring, FDDI, etc.

FIG. 5 is a block diagram showing the configuration of the file server 3 according to the present embodiment. The file server 3 is a computer with functions to store and transfer files, and as shown in FIG. 5 is equipped with a control unit 31, a storage unit 32, a display unit 33, an input unit 34, and a communication interface 35, alls of which are connected with each other via a bus 3 for exchanging signals.

The control unit 31 is a CPU, controls various components described above, and executes various arithmetic processes according to a program. The storage unit 32 consists of a ROM for storing various programs and parameters, a RAM for storing programs and data temporarily as a working area, a hard disk for storing OS (operating system and basic software), programs, parameters and the likes for controlling various operations of the file server 3 as well as scanned image data delivered from the PC 2, and others.

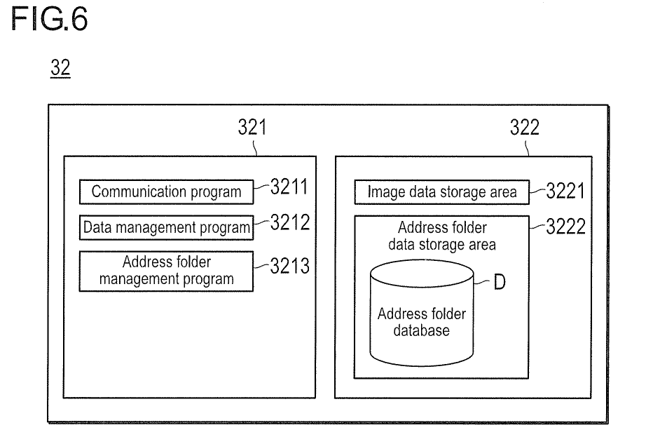

FIG. 6 is a block diagram showing the configuration of the storage unit 32. As shown in FIG. 6, the storage unit 32 contains a program storage area 321 for storing various programs, and a data storage area 322 for storing various data including scanned image data delivered from the PC 2.

The program storage area 321 stores a communication program 3211 for communicating with the PC 2 and others to exchange various data, a data management program 3212 for managing scanned image data delivered from the PC 2, and a address folder management program 3213 for managing the address folder database D, which will be described later.

The data storage area 322 contains an image data storage area 3221 for storing the scanned image data delivered from the PC 2, a address folder data storage area 3222 for storing the address folder database D (to be described later) for collectively storing and managing various data corresponding to the individual address folders on the file server 3, and others. The image data storage area 322 is provided with the address folder(s), and the scanned image data from the PC 2 will be stored in a particular folder designated by the PC 2 among the address folders.

The display unit 33 is a CRT display, a liquid crystal display and the likes, and displays various kinds of information for user. The input unit 34 consists of keyboard, mouse and the likes, for acquiring various instructions from user. The communication interface 34 is an interface for communicating with other devices on the network 3 using protocols such as Ethernet, Token Ring, FDDI, etc.

The file server 3 of the present embodiment can have a so-called document management application installed, and each of the address folders is subject to various data receiving constrains imposed by the document management application. The data receiving constrains include, for example, a constrain in data format of the data for delivery, a constrain in data size of the data for delivery, a constrain based on whether or not the check-out of the existing data in the address folders is currently in progress for the purpose of version management of that data, and a constrain based on whether or not data delivery to the address folders is subject to approval.

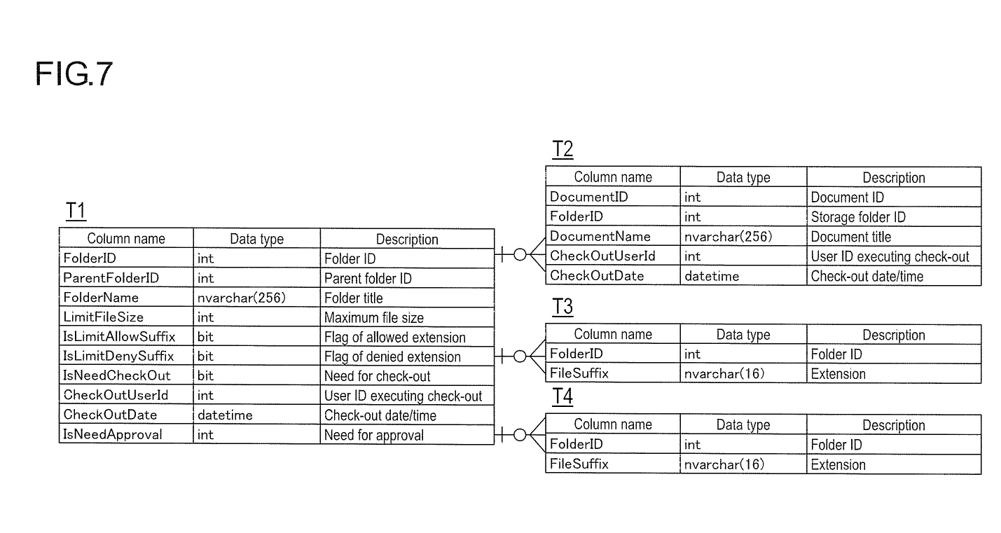

FIG. 7 is an ER (Entity Relationship) diagram showing an example of the configuration of the address folder database D. As described before, the address folder database D is a database for collectively storing and managing various information on the individual address folders on the file server 3.

As shown in FIG. 7, the address folder database D of the present embodiment consists of a folder information table T1 corresponding to each folder, one or more document information table T2 corresponding to each folder information table T1, an allowed extension table T3, and a denied extension table T4.

The folder information table T1 stores the basic information on each of the address folders. The document information table T2 corresponds to each document stored in the delivery destination folder and stores various kinds of information related to the particular document. The allowed extension table T3 is created when the address folders are configured so that they can only store data with certain extensions i.e. allowed extensions, and corresponds to each of the allowed extensions. Similarly, the rejection extension table T4 is created when the address folder are configured so that they cannot store data with certain extensions i.e. denied extensions, and corresponds to each of the denied extensions. As per the description in FIG. 7, the address folder database D of the present embodiment stores information on the maximum receivable data size by the address folders (“Limit Files Size” in the folder information table T1), the allowed/denied extensions by the address folders (“FileSuffix” in the allowed/denied extension table T3/T4), the need for check-out of data in the address folders for the purpose of the version management (“IsNeedCheckOut” in the folder information table T1), and the need for approval for data delivery to the address folders (“IsNeedApproval” in the folder information table T1), etc., which represents various data receiving constrains imposed on the address folders. These pieces of information are acquired by the PC 2 and are used to confirm whether the abovementioned data receiving constrains will be cleared or not for data delivery to the address folders. This will be described in more detail later.

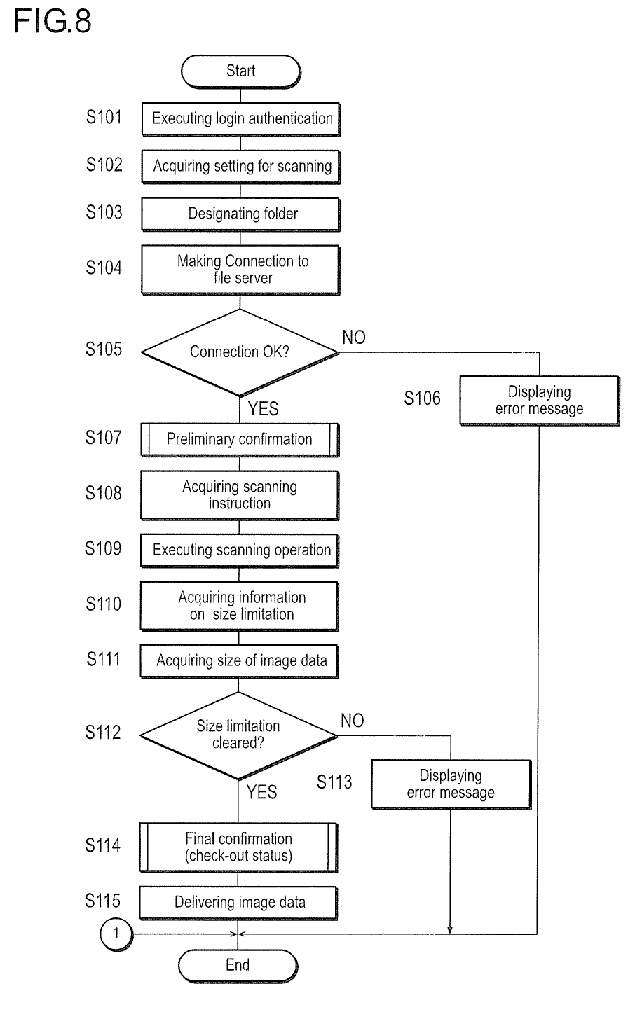

The following is the outline of the operation of the image forming system A in the present embodiment. FIG. 8 is a flowchart to show the sequence of the steps executed by PC 2 according to the present embodiment for delivering the scanned image data generated by the MFP 1 to the file server 3. The algorithm shown in the flowchart of FIG. 8 is stored as a control program on memory 22 of the PC 2, and is read out and executed by control unit 21 when the operation starts.

First of all, the PC 2 executes the login authentication of the user who attempts to have a document image to be scanned by the MFP1 (S181). More specifically, the PC 2 acquires user's login information (user ID and password) by means of the UI screen u1 for login authentication displayed on the display unit 23, and executes login authentication by comparing the acquired information with the login authentication information stored in the authentication data storage area 2223.

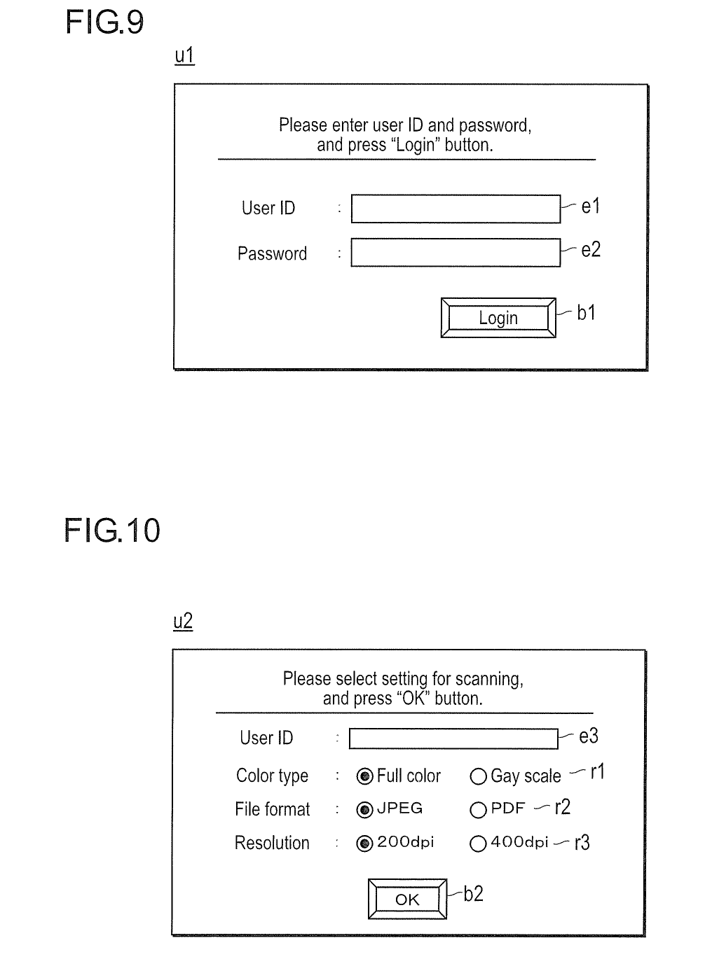

FIG. 9 shows an example of the UI screen u1 for login authentication. As shown in FIG. 9, the UI screen u1 contains text input fields e1 and e2 for receiving inputs of the user ID and the password respectively, the login execution button b1, etc. The PC 2 can acquire login information when the user enters the login information into the text input fields e1 and e2 and then press the execution button 1.

Subsequently, the PC 2 displays the UI screen u2 for setting the scanning operation on the display unit 23, and acquires setting values for the scanning operation by the MFP1 (S102). FIG. 10 shows an example of the UI screen u2 for setting the scanning operation. As shown in FIG. 10, the UI screen u2 contains a text input field e3 for allowing user to input the file name of the scanned image data to be generated by the scanning operation by the MFP 1, a radio button r1 for allowing user to select color type of the scanned image data (e.g., “full color” or “gray scale”), a radio button r2 for allowing user to select file format of the scanned image data, a radio button r3 for allowing user to select resolution for the scanning operation, a confirmation button b2 for confirming the contents specified on the UI screen u2. The PC 2 can acquire setting values for the scanning operation when user presses the confirmation button b2 after entering a proper file name into the text input field e3 and selecting the radio buttons r1-r3 properly.

Subsequently, the PC 2 designates a folder among the address folders, as a destination of the data for delivery (hereinafter also called “delivery destination folder”), by means of the UI screen u3 for folder designation displayed on the display unit 23 (S103).

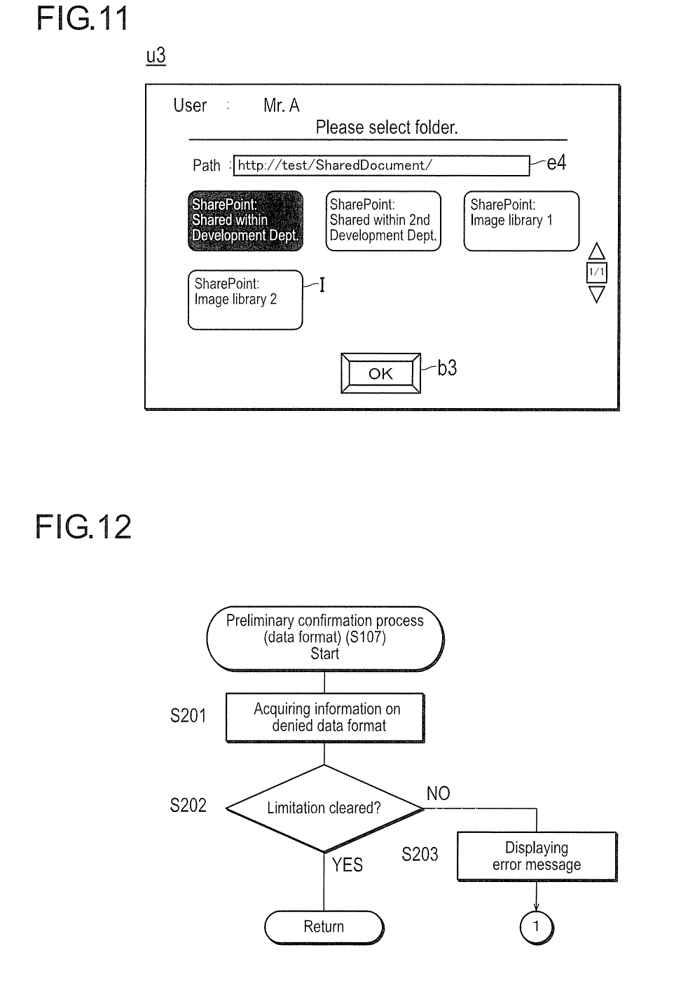

FIG. 11 shows an example of UI screen u3 for folder designation. As shown in FIG. 11, the UI screen u3 contains icons I, each of which corresponds to each of the address folders, a text input field e4 for allowing user to directly enter the path to the designated folder, a confirmation button b3 for allowing user to confirm the contents specified on the UI screen u3, and others. The PC 2 can designated the delivery destination folder when user presses the confirmation button b3 after highlighting an icon I by clicking, or entering a direct path into the text input field e4.

Subsequently, the PC 2 attempts to make a connection with the file server 3 containing the delivery destination folder designated in S103 (S104). If the connection to the file server 3 fails (S105: No), the PC 2 displays an error message screen (not shown) on the display unit 23 (S106), and terminates the entire process without generating the scanned image data or delivering it to the designated folder (End).

On the other hand, if the connection to the file server 3 succeeds (S105: Yes), the PC 2 acquires necessary information from the file server 3, and then confirms whether or not the data receiving constrains imposed on the delivery destination folder will be cleared for the delivery of the scanned image data (S107). This confirmation is executed prior to the generation of the scanned image data, and therefore is called “preliminary confirmation”, in comparison with the final confirmation in S110-S114 which is executed after the generation of the scanned image data.

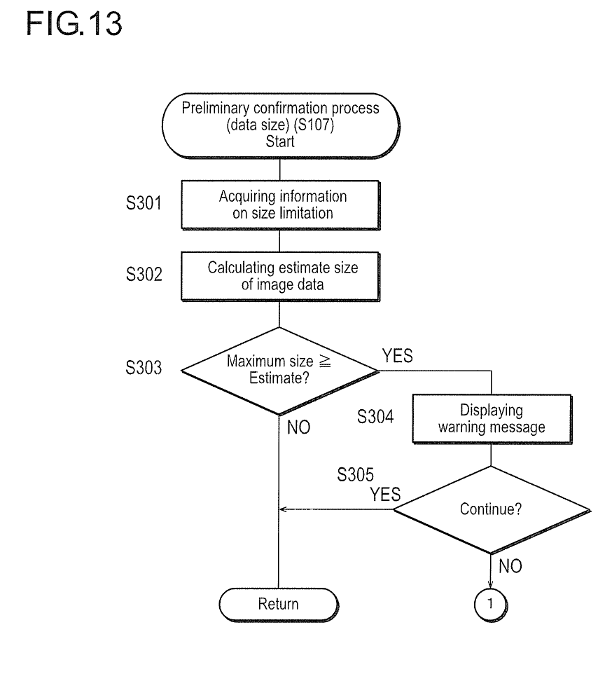

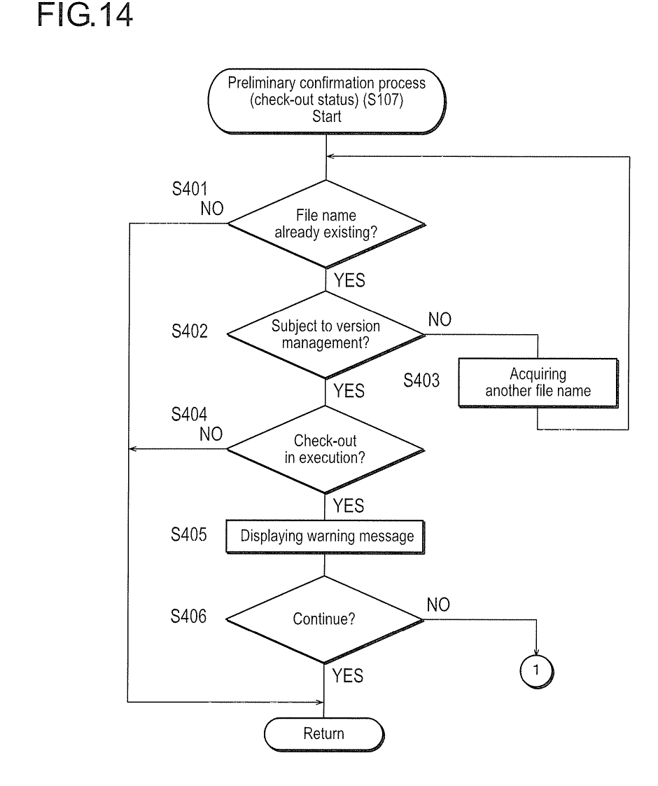

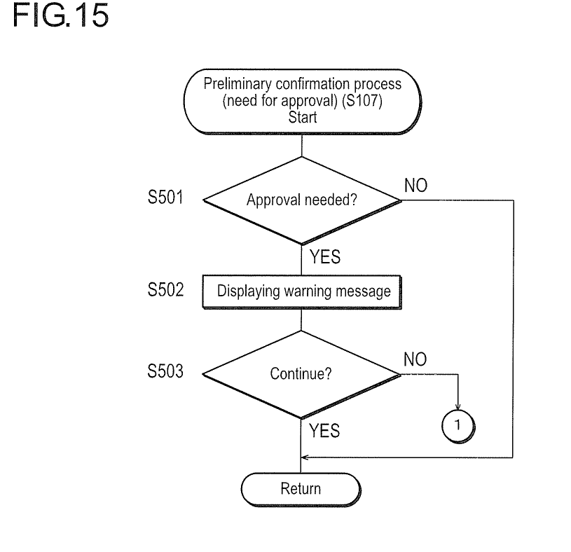

While use can choose what data receiving constrain should be subject to the preliminary confirmation, the relevant flowcharts according to this embodiment prescribe that the data receiving constrain in data format (FIG. 12), the data receiving constrain in data size (FIG. 13), the data receiving constrain based on whether or not check-out of data in the delivery designation folder is currently in progress for the purpose of the version management (FIG. 14), and the data receiving constrain based on whether data delivery to the delivery destination folder needs approval (FIG. 15) is subject to the preliminary confirmation, respectively. As a matter of course, any other constrains than those listed above can be subject to the preliminary confirmation. The processes shown in FIGS. 12-15 will be executed sequentially when all of those data receiving constrains are subject to the preliminary confirmation.

The following is a description of the preliminary confirmation regarding data format (S107), with reference to the flowchart of FIG. 12.

In FIG. 12, the PC 2 acquires the information on the data format to be denied by the delivery destination folder, from the host computer on line (S201). More specifically, the value of “FileSuffix” is acquired from the denied extension table T4 in the address folder database D stored in the storage unit 32.

Subsequently, the PC 2 confirms whether or not the constrain in data format imposed on the delivery destination folder will be cleared for the data delivery, by comparing the setting values for data format acquired in S102 with the information acquired in S201 (S202).

If the PC2 confirms that the constrain in data format will be cleared (S202: Yes), i.e., if the extension corresponding to the data format specified in S102 is not included in the “FileSuffix” acquired in S201, the PC2 returns to the flowchart of FIG. 8 without displaying the error message m1 discussed later (Return). On the other hand, if the PC 2 confirms that the constrain in data format will not be cleared (S202: No), i.e., if the extension corresponding to the data format specified in S102 is included in the “FileSuffix” acquired in S201, the PC 2 displays the error message m1 indicating that the current settings for data format of the scanned image data is faulty, on the display unit 23 (S203) and terminates the entire process (End of FIG. 8).

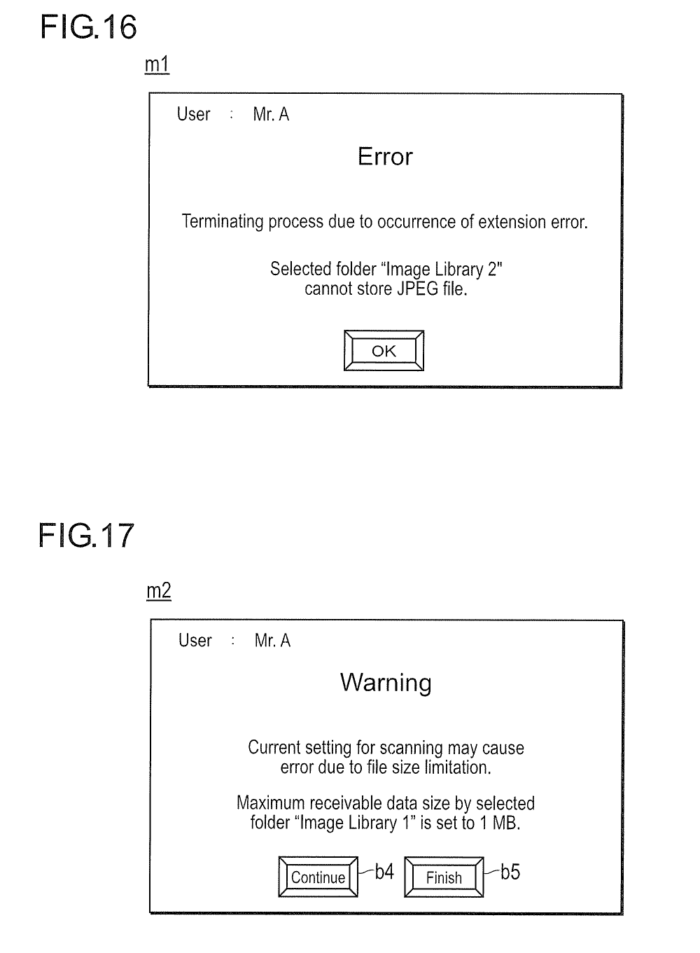

FIG. 16 is a diagram showing an example of the error message m1 to be displayed in S203. Apart from this example, the error message m1 can be provided with buttons for prompting user to change settings for the scanning operation and to select another folder as delivery designation, in order to cause the PC 2 to return to S102 and S103, respectively.

The following is a description of the preliminary confirmation regarding data size (S107), with reference to the flowchart of FIG. 13.

In FIG. 13, the PC 2 acquires the information on the maximum receivable data size by the delivery destination folder, from the host computer on line (S301). More specifically, the value of “LimitFileSize” (hereinafter called “S1”) is acquired from the folder information table T1 stored in the storage unit 32.

Furthermore, the PC 2 calculates an expected size (S2) of the scanned image data, based on the setting values for the scanning operation acquired in S102 (more specifically, settings values for color type, file format, and resolution) (S302). The PC 2 compares the abovementioned values S1 and S2 (S303), and returns to the flowchart of FIG. 8 without displaying the warning message m2 described later if S1≧S2 (S303: No), i.e., if the expected size of the scanned image data (S2) is equal to or smaller than the maximum receivable data size of the delivery destination folder.

On the other hand, if S1<S2 (S303: Yes), i.e., if the expected size of the scanned image data (S2) is greater than the maximum receivable data size by the delivery destination folder, the PC 2 displays the warning message m2 indicating that the data size of the scanned image data is faulty, on the display unit 23 (S304).

FIG. 17 is a diagram showing an example of the warning message m2 displayed in S304. As shown in FIG. 17, the warning message m2 contains a continuation button b4 and a termination button b5 allowing user to choose either continuation or termination of the entire process. Apart from this example, the warning message m2 can be provided with buttons for allowing user to change the settings for the scanning operation and to select another folder as delivery destination, in order to cause the PC 2 to return to S102 and S103, respectively.

If use chooses continuation of the process on the warning message m2 (S305: Yes), in other words, if the continuation button b4 on the warning message m2 is pressed, the PC 2 returns to the flow chart of FIG. 8 (Return). On the other hand, user chooses termination of the process (S305: No), in other words, if the termination button b5 on the warning message m2 is pressed, the PC 2 terminates the process without executing the generation and delivery of the scanned image data (End on FIG. 8).

The following is a description of the preliminary confirmation regarding check-out status (S107), with reference to the flowchart of FIG. 14.

In FIG. 14, the PC 2 acquires the names of all the files in the delivery destination folder, from the file server 3 on line (more specifically, acquiring the value of “DocumentName” from all the document information tables T2 corresponding to the delivery destination folder in the address folder database D, and confirms whether or not the file name of the scanned image data acquired in S102 coincides with any of the file names already existing in the delivery destination folder (S401).

If the file name does not coincides (S401: No) i.e. there is no file with the same file name as the scanned image data in the delivery destination folder, the PC 2 returns to the flowchart of FIG. 8 without displaying the warning message m3 described later (Return) as there will be no need for considering whether or not data in the delivery destination folder is subject to version management. On the other hand, if the file name coincides (S401: Yes) i.e. there is a file with the same name as the scanned image data in the delivery destination folder, the PC 2 further confirms whether or not the data in the delivery destination folder is subject to version management (S402). The confirmation in S402 includes the step of acquiring the “IsNeedCheckOut” value from the folder information table T1 in the address folder database D.

If the data in the delivery destination folder is not subject to version management (S402: No), in other words, if the value of “IsNeedCheckOut” value acquired from the file server on line is “False”, the PC 2 prompts user to change the name of the scanned image data in order to avoid the coincidence with the existing file name, displays a warning message (not shown) prompting user to enter a new file name, on the display unit 23, and then returns to S401 after acquiring a new file name (S403).

On the other hand, if the data in the delivery destination folder is subject to version management (S402: Yes), in other words, the value of “IsNeedCheckOut” acquired from the file server on line is “True,”, the PC 2 further confirms whether or not the check-out of the existing file with the same name as the scanned image data (hereinafter also called “file for version management”) is currently in progress (S404). This confirmation in S404 can be accomplished by confirming whether or not the file for version management is being locked. As can be seen in the above, the PC 2 acquires from the file server 3 on line, the information on the check-out status of the data in the delivery destination folder in the steps of S401-S404.

If check-out of the file for version management is not in progress (S404: No), in other words, that particular file is not being locked, the file for version management can be updated with the scanned image data to be generated thereafter, the PC 2 can return to the flowchart of FIG. 8 without displaying the warning message m3 described later (Return). On the other hand, if check-out of the file for version management is in progress (S404: Yes), in other words, that particular file is being locked, the PC 2 displays on the display unit 23 the warning message m3 indicating that the check-out status of the data in the delivery destination folder is faulty (S405).

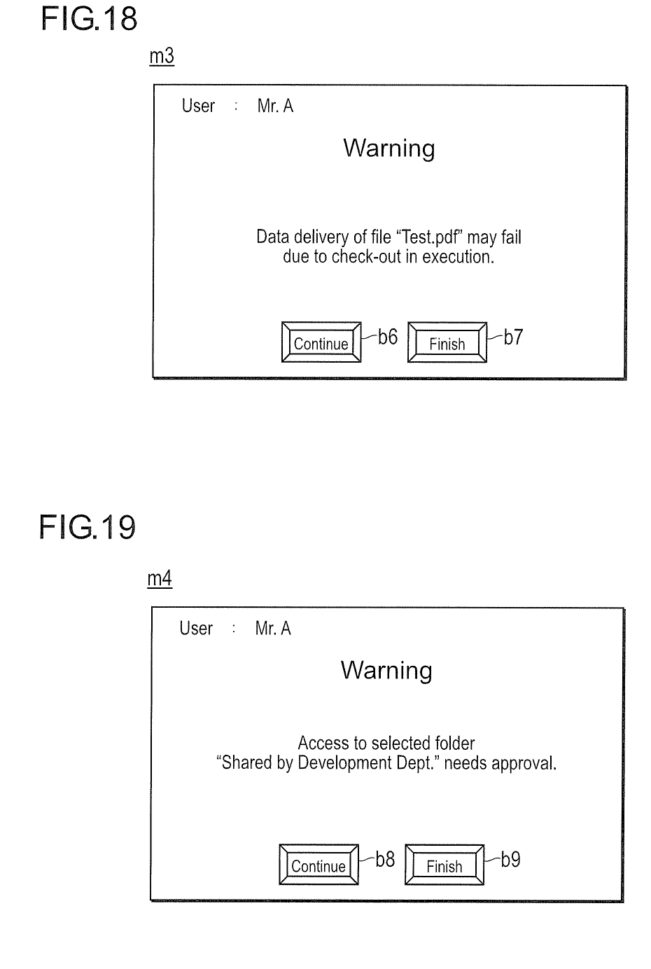

FIG. 18 is a diagram showing an example of the warning message m3 displayed in S405. As shown in FIG. 18, the warning message m3 contains a continuation button b6 and a termination button b7 allowing user to choose either continuation or termination of the process. Apart from this example, the warning message m3 can be provided with a button for changing the delivery destination folder to cause the PC 2 to return to the step of S103 when being pressed.

If user chooses continuation of the process on the warning message m3 (S406: Yes), in other words, if the continuation button b6 on the warning message m3 is pressed, the PC 2 returns to the flow chart of FIG. 8 (Return). On the other hand, if user chooses termination of the process (S406: No), in other words, if the termination button b7 on the warning message m3 is pressed, the PC 2 terminates the process without generating or delivering the scanned image data (End on FIG. 8).

The following is a description of the preliminary confirmation regarding the need for approval (S107), with reference to the flowchart of FIG. 15.

In FIG. 15, the PC 2 acquires the information indicating whether or not data delivery to the delivery destination folder needs approval, from the file server 3 on line (more specifically, acquiring the value of “IsNeedApproval” from the folder information table T1 corresponding to the delivery designation folder in the address folder database D, and confirms whether or not data delivery to the folder needs approval (S501) based on the value acquired. If the data delivery does not need approval (S501: No), i.e., if the value of “IsNeedApproval” acquired is “False”, the PC 2 returns to the flowchart of FIG. 8 without displaying the error message m4 described later (Return). On the other hand, if the data delivery needs approval (S501: Yes), i.e., if the value of “IsNeedApproval” acquired is “True”, the PC 2 displays on the display unit 23 the warning message m4 indicating that delivery of the scanned image data needs approval (S502).

FIG. 19 is a diagram showing an example of the warning message m4 displayed in S502. As shown in FIG. 19, the warning message m4 contains a continuation button b8 and a termination button b9 for allowing user to choose either continuation or termination of the process. Apart from this example, the warning m4 can be provided with a button for changing the delivery destination to cause the PC 2 return to S103 when being pressed.

If user chooses continuation of the process on the warning message m4 (S503: Yes), in other words, if the continuation button b8 on the warning message m4 is pressed, the PC 2 returns to the flow chart of FIG. 8 (Return). On the other hand, if user chooses termination of the process (S406: No), in other words, if the termination button b7 on the warning message m3 is pressed, the PC 2 terminates the process without generating or delivering the scanned image data (End of FIG. 8).

When the abovementioned preliminary confirmation (S107) finishes, the PC 2 acquires an instruction from user to proceed with the scanning operation (S108). More specifically, the PC 2 acquires the instruction from user by means of an UI screen (not shown) displayed on the display unit 23. Having acquired the instruction from user, the PC 2 remote-controls the MFP 1 using the scanner driver 2211 in order to cause the image scanning unit 14 to perform the scanning operation (S109). The PC2 then receives the scanned image data generated and transmitted by the MFP 1, and stores it in the image data storage area 2221 (S109).

Subsequently, the PC 2 acquires from the file server 3 on line, information on the maximum receivable data size by the delivery destination folder, which will be use for the purpose of confirming, prior to the actual delivery of the scanned image data in S115, whether or not the constrain in data size imposed on the delivery designation folder will be finally cleared (S110). More specifically, the PC 2 acquires the value of “LimitFileSize” from the folder information table T1 corresponding to the delivery destination folder in the address folder database D.

The PC 2 then acquires the file size of the scanned image data stored in the image data storage area 2221 in S109 (S1111), and confirms whether or not the constrain in data size will be cleared (S112), by comparing the acquired file size and the value of “LimitFileSize”. Although a similar confirmation has already been carried out within the preliminary confirmation shown in FIG. 13 (refer to S303), the preliminary confirmation only refers to an estimated value of the file size, and therefore cannot necessarily guarantee accurate confirmatory results. Therefore, this final confirmation followed by the preliminary confirmation as shown in FIG. 13 will be useful.

If the PC 2 confirms that the constrain in data size will be cleared (S112: Yes), in other words, if the actual size of the scanned image data acquired in S11 is smaller than the value of “LimitFileSize” acquired in S110, the PC 2 further proceeds with the final confirmation of the check-out status in S114. This final confirmation will he described later. On the other hand, if the PC 2 confirms that the size constrain in data size will not be cleared (S112: No), in other words, the actual data of the scanned image data is greater than the value of “LimitFileSize”, the PC 2 displays on the display unit 23 an error message (not shown) indicating that the scanned image data cannot be delivered to the delivery destination folder due to its defective file size (S113), and terminates the process without delivering the scanned image data.

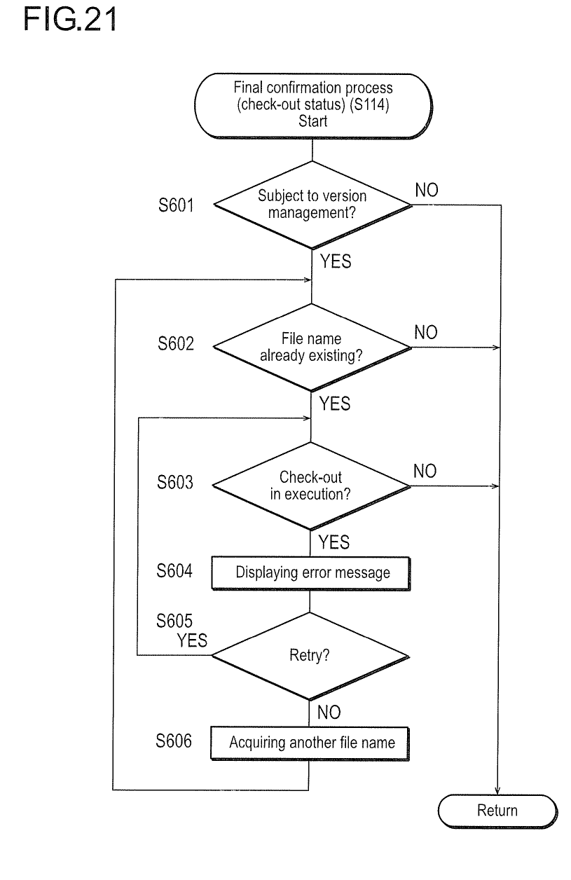

In S114, the PC 2 finally confirms whether or not the constrain due to the check-out status will be cleared or not. The details of the final confirmation will be described below with reference to the flowchart of FIG. 21. Although a similar confirmation has already been carried out within the preliminary confirmation shown in FIG. 14, this final confirmation will also be useful as the check-out status is constantly changing.

First of all, the PC 2 confirms whether or not the delivery destination folder is subject to version management, based on the information acquired from the file server 3 on line (S601). More specifically, the PC 2 acquires the value of “IsNeedCheckOut” from the folder information table T1 corresponding to the delivery destination folder in the address folder database D, and confirms whether or not this value is “True” or “False”.

If the delivery destination folder is not subject to version management (S601: No), in other words, if the value of “IsNeedCheckOut” is “False”, it turns out to be unnecessary to consider the constrain regarding the check-out status, and therefore the PC 2 returns to the flowchart of FIG. 8 (Return) without displaying the warning message m5 described later, and terminates the process after delivering the scanned image data to the file server 3 on line (S115).

On the other hand, if the delivery destination folder is subject to version management (S601: Yes), in other words, the value of the “IsNeedCheckOut” acquired is “True”, the PC 2 further confirms whether or not the file name of the scanned image data acquired in S102 coincides with the file name of any existing file in the delivery destination folder (S602). The details of this confirmation are similar to those of S401. If the file name does not coincides (S602: No) i.e. no file with the same file name as the scanned image data exists, it turns out to be unnecessary to consider the check-out status. Therefore, the PC 2 returns to the flowchart of FIG. 8 (Return) without displaying the warning message m5 described later, and terminates the process after delivering the scanned image data to the file server 3 on line (S115).

On the other hand, if the file name coincides (S602: Yes), i.e. there is a file for version management with the same name as the scanned image data in the delivery destination folder, the PC 2 further confirms whether or not check-out of the file for version management is currently in progress (S603). Details of this confirmation are the same as those of S404. As can be seen in the above, the PC 2 acquires from the file server 3 on line, information on the check-out status of the data in the delivery destination folder in accordance with the steps of S601-S603.

If the check-out of the file for version management is not currently in progress (S603: No), the PC 2 can update that particular file with the scanned image data, and therefore returns to the flowchart of FIG. 8 (Return) without displaying the warning message m5 described later and terminates the process (End) after delivering the scanned image data to the file server 3 on line (S115).

In the meanwhile, once the file server 3 receives the scanned image data, the file for version management in the delivery destination folder will be checked out to the version management registry in the storage unit 32. Subsequently, this file will be updated with the scanned image data delivered from the PC 2 and then checked into the delivery designation folder.

In S603 described above, if the check-out of the file for version management is currently in progress (S603: Yes), the PC 2 displays on the display unit 23 the warning message m5 indicating that the scanned image data cannot be delivered at the moment as the check-out for version management is in progress (S604).

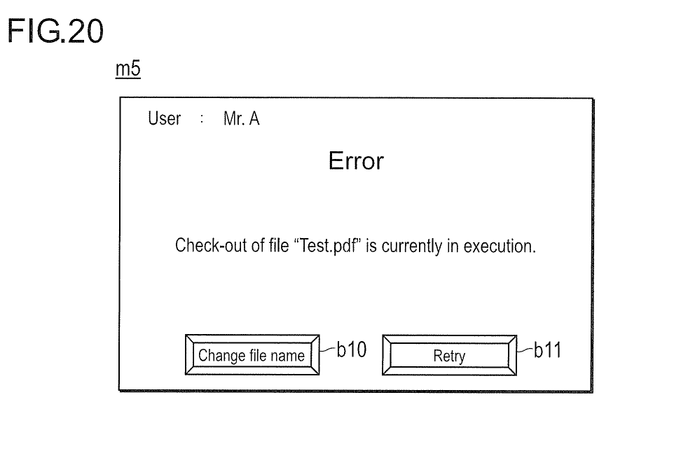

FIG. 20 is a diagram showing an example of the warning message m5 displayed in S604. As shown in FIG. 20, the warning message m5 is provided with a file name change button b10 for delivering the scanned image data as a new file, and a retry button b11 for confirming whether or not the check-out of the file has been finished yet, so that user can choose either file name change or retry.

If use chooses retry on the displayed warning message m5 (S605: Yes), in other words, a retry button b11 is pressed, the PC 2 returns to S603, and confirms again whether or not the check-out of the file has been finished yet. If the check-out has been finished at this stage, the PC 2 returns to the flowchart of FIG. 8 in order to deliver the scanned image data to the file server 3 (S115).

On the other hand, if user doesn't choose retry (S605: No), in other words, the file name change button b10 is pressed, the PC 2 displays the UI screen for file name change (not shown) (S606) to acquire a new file name, and then returns to S602. If the file name is properly changed, the scanned image data will be delivered to the file server 3, and stored in the delivery destination folder as a normal file (rather than an updated version of the file for version management).

As can be seen from the above, the image forming system A according to the present embodiment makes it possible to confirm whether or not various data receiving constrains imposed by a document management application, etc. on the delivery destination folder are cleared for the data delivery, and to display, in the case where some of the constrains are not cleared, the fact that these particular constrains are not cleared. As a result, user can learn not only the availability of the delivery destination folder for the data delivery, but also the reason for the unavailability as appropriate, prior to the actual date delivery to the delivery destination folder. In other words, the present invention enables user to avoid inconveniences caused by an error in data delivery due to data receiving constrains imposed on a delivery destination folder.

For executing the data delivery process shown in the flowchart of FIG. 8, the system utilizes the UI screen u3 for folder designation as shown in FIG. 9 as means to designate the delivery destination folder (S103), and applies the abovementioned preliminary confirmation process only to the delivery destination folder (S107), but the present embodiment is not necessarily limited to this. For example, the system can also be configured to apply the preliminary confirmation process to all the address folders prior to the folder designation, and then to designate the delivery destination folder by means of the UI screen u4 for displaying information on the data receiving constrains imposed on and the preliminary confirmation results obtained for all the address folders.

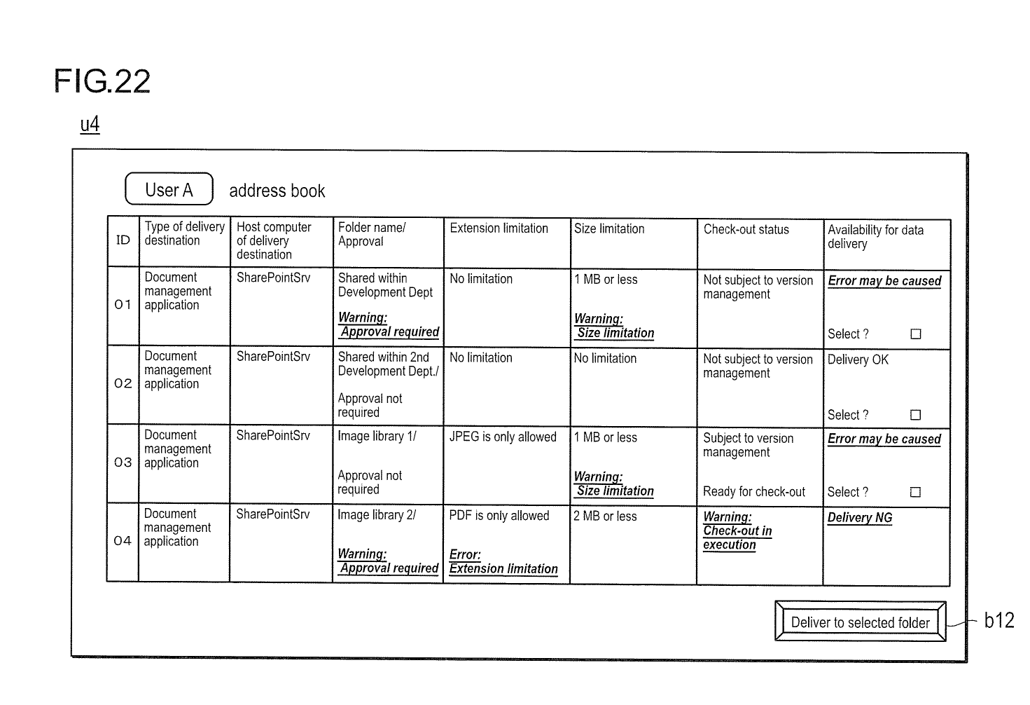

FIG. 22 shows an example of the UI screen u4 for folder designation. As shown in FIG. 22, the UI screen u4 includes a list of the address folders: each of the rows corresponds to each of the address folders, and each of the columns corresponds to each of the data receiving constrains imposed on the address folders. The columns “Folder Name/Approval Required or Not”, “Extension Constrain”, “Size Constrain”, and “Checkout Condition” correspond to the constrain regarding the need for approval, the constrain in data format of the scanned image data, the constrain in data size of the scanned image data, and the constrain due to the check-out status of the data in the address folder respectively. The UI screen u4 can also display an error/warning message, in addition to the details of each data receiving constrain, when any data receiving constrain is not cleared. The “Delivery Yes/No” column indicates whether or not the data delivery to each address folder is available or not based on the preliminary confirmation result; more specifically, “DeliveryNG” emerges if any of the cells for a folder includes an error message, “Error may be caused” emerges if none of the cells for a folder includes an error message but any of the cells includes a warning message, and “DeliveryOK” emerges if none of the cells for a folder includes an error message or warning message. Among those indicators, “Delivery OK” and “Error may be caused” will be accompanied by a check box C for designate a particular folder as the delivery destination folder. The UI screen U4 can also be provided with a confirmation button b12 for allowing user to confirm the settings specified on the UI screen u4. Therefore, this UI screen u4 will enable user to select with ease the most suitable folder for data delivery, and consequently enhances user-friendliness of the system.

### Second Embodiment

Descriptions of the second embodiment will be provided as follows with a focus on the differences from the first embodiment.

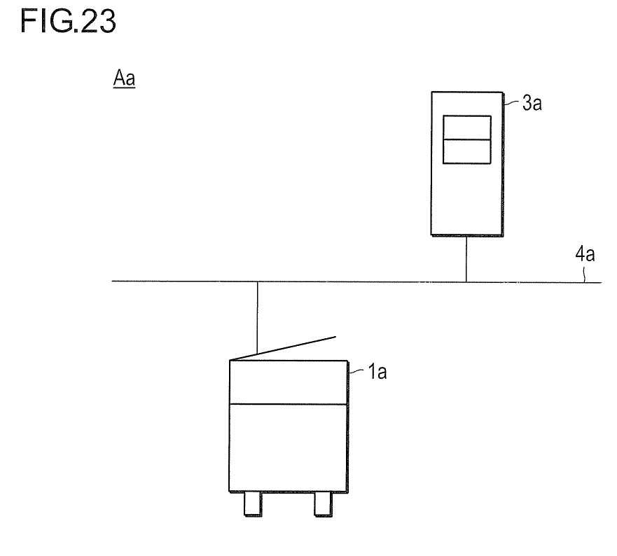

FIG. 23 is a block diagram showing the overall configuration of an image forming system Aa according to the second embodiment of the present invention. As shown in FIG. 23, the image forming system Aa has an MFP 1a, which is equipped with a scanning function for scanning a document to generate image data as well as a data delivery function for delivering the generated image data to a host device designated by user, and one or more file servers 3a which can be delivery destinations of the image data, and all of them are connected via a communication network 4a such as the Internet, LAN, and WAN. The types and the number of equipment to be connected to the communication network 4 are not limited to the example shown in FIG. 23. The image forming system Aa of the present embodiment is different from the image forming system A of the first embodiment in that the system Aa is not provided with an independent data delivery apparatus and the MFP 1a itself has a data delivery function.

The configuration of each device will be described below while each device can include any other constituents than those described below, and can include only a part of the constituents described below. The description of any function common to more than one device will be made only once, and will not be repeated in order to avoid redundant descriptions.

First of all, a description of the configuration of the MFP 1a of this embodiment is provided as follows: The MFP 1a of this embodiment is equipped with a control unit 11a, a storage unit 12a, an input unit 13a, an image scanning unit 14a, a printing unit 15a, and a communication interface 16a, all of which are interconnected by a bus 17a for exchanging signals, similar to the first embodiment. The configuration of each unit is similar to that of the MFP 1 of the first embodiment except for the storage unit 12a and the operating unit 13a, and therefore, details of the storage unit 12a and the operating unit 13a will be given below.

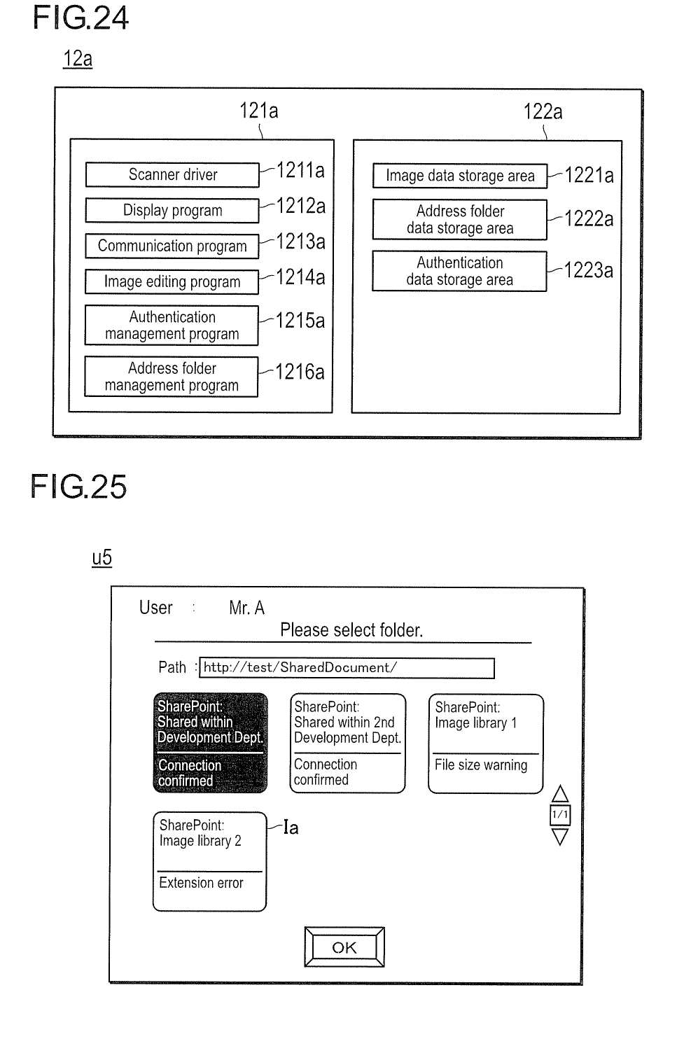

The memory unit 12a includes a ROM for storing various programs and parameters, a RAM for temporarily storing programs and data, a hard disk used for temporarily storing the image data generated by the image scanning device 14, and others. FIG. 24 is a block diagram showing the configuration of the storage unit 12a. As shown in FIG. 24, the storage unit 12a includes the program storage area 121a for storing various programs and a data storage area 122a for storing scanned image data to be delivered.

The program storage area 121a stores a scanner driver 1211a for configuring the scanning function of the MFP 1 and causing the MFP 1 to execute the scanning operation by the image scanning unit 14a; a display program 1212a for displaying various UI screens for setting the scanning operation in conjunction with the scanner driver 1211a; a communication program 1213a for exchanging various data with the file server 3; an image editing program 1214a for editing the scanned image data, etc.; an authentication management program 1215a for managing login authentication to the MFP 1, etc.; and a address folder management program 1216a for managing the address folders.

The data storage area 122a is provided with an image data storage area 1221a for storing the scanning image data generated by the image scanning unit 14a, a address folder data storage area 1222a for storing the information on each of the address folders, an authentication data storage area 1223a for storing login authentication information of pre-registered users of the MFP 1, and others.

The input unit 13a is equipped with a touch panel 131a for displaying various kinds of information, and for acquiring user's instruction regarding the settings for the MFP 1. The touch panel 131a of the present embodiment displays various UI screens such as those shown in FIGS. 9-11 and various error/warning message screens such as those shown in FIGS. 16-20.

The file server 3a of the present embodiment is similar to the file server 3 of the first embodiment. In other words, the storage unit of the file server 3a stores an address folder database Da for collectively storing and managing various data corresponding to each of the address folders in the file server 3a.

The MFP 1a of the present embodiment executes the image data delivery process as well as its accompanying preliminary confirmation process and final confirmation process according to the procedures similar to those of the flowcharts shown in FIG. 8, FIGS. 12-15, and FIG. 21. Therefore, the description of the processes the MFP 1a performs in the present embodiment is omitted. However, in the present embodiment, UI screens u1-u3 and error/warning message images m1-m5 are displayed on the touch panel 131a of the MFP 1a and user inputs various settings by touching the touch panel 131a.

As can be seen in the above, the present embodiment can exert similar effects to those of the first embodiment, by means of a simplified system without an independent data delivery apparatus.

For executing the data delivery process shown in the flowchart of FIG. 8, the system utilizes the UI screen u3 for folder designation as shown in FIG. 23a as means to designate the delivery destination folder (S103), and applies the abovementioned preliminary confirmation process to the delivery destination folder alone (S107), but the present embodiment is not necessarily limited to this. For example, the system can also be configured to apply the preliminary confirmation process to all the address folders prior to the folder designation, and then to designate the delivery destination folder by means of the UI screen u5 for displaying information on the preliminary confirmation results obtained for all the address folders.

FIG. 25 shows an example of the UI screen u5 for folder designation. As shown in FIG. 25, the UI screen u5 includes icons Ia, each of which corresponds to each of the address folders like the aforementioned UI screen u3, but each of the icons Ia may also include error/warning messages indicating that some of the data receiving constrains are not cleared. Therefore, this UI screen u5 will enable user to select with ease the most suitable folder for data delivery, and consequently enhances user-friendliness of the system.

This invention is not limited to the embodiments described above, but also can be changed in various ways within the range of the descriptions in the claims. The data delivery apparatus according to this invention can be realized by a dedicated hardware circuit for executing the abovementioned steps, or by causing a CPU to execute a program where said steps are described. If the present invention is to be materialized by the latter, said programs for operating the data delivery apparatus can be provided by computer-readable recording media such as a floppy disk (a registered trademark) and CD-ROM, or can be provided on line via a network such as Internet. In this case, the program recorded on the computer readable recording medium is normally transmitted to and stored in a memory device such as ROM and a hard disk. The program can also be provided as independent application software or can be built into the software of the data delivery apparatus as a part of its function.

What is claimed is:

1. A data delivery apparatus with a function to deliver data to one or more folders on an external equipment, comprising:
a folder designating unit for designating a delivery destination folder to which said data is to be delivered;
an information acquiring unit for making a connection with said external equipment containing said delivery destination folder and acquiring information on data receiving constrains imposed on said delivery destination folder;
a confirmation unit for confirming whether or not said data receiving constrains will be cleared for the delivery of said data to said delivery destination folder, based on the information acquired by said acquiring unit; and
a display unit for displaying, in the case where said confirmation unit confirms that some of said data receiving constrains on said delivery designation folder will not be cleared, information indicating that said some data receiving constrains will not be cleared.

2. The data delivery apparatus as claimed in claim 1, wherein
said data receiving constrains include at least one of the following constrains: a constrain in data format of said data, a constrain in data size of said data, a constrain based on whether or not check-out of any existing data in said delivery destination folder is currently in progress for the purpose of version management of said existing data, and a constrain based on whether or not data delivery to said delivery destination folder needs approval.

3. The data delivery apparatus as claimed in claim 1, wherein
at least part of said folders are managed by a document management application installed on said external equipment,
said data receiving constrains imposed on said folders managed by said document management application are prescribed by said document management application.

4. A method, executed by a data delivery apparatus with a function to deliver data to one or more folders on an external equipment, for displaying information on said folders, comprising the steps of:
(a) designating a delivery target folder to which said data is to be delivered;
(b) making a connection with said external equipment containing said delivery destination folder and acquiring information on data receiving constrain imposed on said delivery destination folder;
(c) confirming whether or not said data receiving constrains will be cleared for the delivery of said data to said delivery destination folder based, on the information acquired in said step (b); and
(d) displaying, in the case where some of said data receiving constrains on said delivery destination folder will not be cleared in said step (c), information indicating that said some data receiving constrain will not be cleared.

5. The method as claimed in claim 4, wherein
said data receiving constrains include at least one of the following constrains: a constrain in data format of said data, a constrain in data size of said data, a constrain based on whether or not check-out of any existing data in said delivery destination folder is currently in progress for the purpose of version management of said existing data, and a constrain based on whether or not data delivery to said delivery destination folder needs approval.

6. The method as claimed in claim 4, wherein
at least part of said folders are managed by a document management application installed on said external equipment,
said data receiving constrains imposed on said folders managed by said document management application are prescribed by said document management application.

7. A computer readable recording medium stored with program for controlling a data delivery apparatus with a function to deliver data to one or more folders on an external equipment, said program causing said data delivery apparatus to execute the process comprising the steps of:
(a) designating a delivery target folder to which said data is to be delivered;
(b) making a connection with said external equipment containing said delivery destination folder and acquiring information on data receiving constrains imposed on said delivery destination folder;
(c) confirming whether or not said data receiving constrains will be cleared for the delivery of said data to said delivery destination folder, based on the information acquired in said step (b); and
(d) displaying, in the case where some of said data receiving constrains on said delivery destination folder will not be cleared in said step (c), information indicating that said some data receiving constrains will not be cleared.

8. The computer readable recording medium as claimed in claim 7, wherein
said data receiving constrains include at least one of the following constrains: a constrain in data format of said data, a constrain in data size of said data, a constrain based on whether or not check-out of any existing data in said delivery destination folder is currently in progress for the purpose of version management of said existing data, and a constrain based on whether or not data delivery to said delivery destination folder needs approval.

9. The computer readable recording medium as claimed in claim 7, wherein
at least part of said folders are managed by a document management application installed on said external equipment,
said data receiving constrains imposed on said folders managed by said document management application are prescribed by said document management application.

10. A data delivery system for delivering data from a data delivery apparatus to one or more folders on one or more file servers,
wherein said data delivery apparatus comprising: a folder designating unit for designating a delivery destination folder to which said data is to be delivered; an information acquiring unit for making a request to said file server containing said delivery destination folder, for data receiving constrain information on data receiving constrains imposed on said delivery destination folder, and receiving said data receiving constrain information transmitted from said file server; a confirmation unit for confirming whether or not said data receiving constrains will be cleared for the delivery of said data to said delivery destination folder, based on said data receiving constrain information received; and a displaying unit for displaying, in the case where said confirmation unit confirms that some of said data receiving constrains on said delivery destination folder will not be cleared, information indicating that said some data receiving constrains will not cleared,
said file server comprising: a storage unit for storing data receiving constrain information corresponding to each of said folders on said file servers; and an information transmitting unit for reading out said data receiving constrain information stored in said storage unit and transmitting it to said data delivery apparatus, in response to said request from said information acquiring unit.

11. The data delivery apparatus as claimed in claim 10, wherein
said data receiving constrains include at least one of the following constrains: a constrain in data format of said data, a constrain in data size of said data, a constrain based on whether or not check-out of any existing data in said delivery destination folder is currently in progress for the purpose of version management of said existing data, and a constrain based on whether or not data delivery to said delivery destination folder needs approval.

12. The data delivery apparatus as claimed in claim 10, wherein
at least part of said folders are managed by a document management application installed on said external equipment,
said data receiving constrains imposed on said folders managed by said document management application are prescribed by said document management application.

13. A file server containing one or more folders for receiving data delivered from a data delivery apparatus, comprising:
a storage unit for storing data receiving constrain information on data receiving constrains imposed on each of said folder; and
an information transmitting unit for reading out from said storage unit, said data receiving constrain information corresponding to a delivery destination folder designated as a delivery destination of said data by said data delivery apparatus and transmitting it to said data delivery apparatus, in response to a request for data receiving constrain information from said data delivery apparatus.

14. The file server as claimed in claim 13, wherein
said data receiving constrains include at least one of the following constrains: a constrain in data format of said data, a constrain in data size of said data, a constrain based on whether or not check-out of any existing data in said delivery destination folder is currently in progress for version management of said existing data, and a constrain based on whether or not data delivery to said delivery destination folder needs approval.

15. The file server as claimed in claim 13, wherein
at least part of said folders are managed by a document management application installed on said external equipment,
said data receiving constrains imposed on said folders managed by said document management application are prescribed by said document management application.
